(19) United States
(12) Patent Application Publication
(10) Pub. No.: US 2008/0268847 A1
(43) Pub. Date: Oct. 30, 2008

(54) METHOD AND APPARATUS FOR A SERVER TO OBTAIN INFORMATION ABOUT USER PREFERENCES AND SUBSCRIPTIONS

(75) Inventors: Rajat P. Mukherjee, Montreal (CA); Ulises Olvera-Hernandez, Kirkland (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/110,093

(22) Filed: Apr. 25, 2008

Related U.S. Application Data
(60) Provisional application No. 60/913,841, filed on Apr. 25, 2007.

(51) Int. Cl. H04Q 7/20

(52) U.S. Cl. 455/436

(57) ABSTRACT

An apparatus and method makes a decision whether or not to handover a wireless transmit-receive unit to a new network in a wireless or fixed network communication system. In a specific embodiment, a media-independent handover application server, operating according to IEEE 802.21 protocol, exchanges information with a server by using a Third Generation Partnership Project standardized interface. The method allows for an IMS based handover server to extract user preference and subscription information from a subscription server. The improvement allows new kinds of information to be exchanged between the handover and subscription server for optimized handover decisions.

### CROSS REFERENCE TO RELATED APPLICATIONS

This application claims the benefit of U.S. Provisional Application No. 60/913,841 filed on Apr. 25, 2007, which is incorporated by reference as if fully set forth.

### TECHNOLOGY FIELD

A method and apparatus related to wireless communications. More particularly, a method and apparatus enabling a server to download user preferences and subscriptions, further enabling handover between networks, are disclosed.

### BACKGROUND

The IEEE 802.21 standard defines three main services that help mobility management entities in a terminal and network to make handover and handover related decisions. These are the Media Independent Handover (MIH) Information, Event, and Command services.

The Third Generation Partnership Project (3GPP) group is currently working on the radio and architecture aspects of the Long Term Evolution of the 3GPP cellular system. Within this framework, mobility management, and specifically handover between different RATs (Radio Access Technologies), have received particular attention.

Currently, there are no standardized interactions between 3GPP Core Network elements and any IEEE mobility management entity (such as an 802.21 MIH server). However, it has been previously shown how an MIH server may be introduced as an Internet Protocol Multimedia Subsystem (IMS) Application Server (AS). Functionally, this MIH AS uses the 802.21 protocol, using the Session Initiation Protocol (SIP)-based signaling for IMS, to communicate with a suitable wireless transmit/receive unit (WTRU). Further a generic protocol has been developed that allows this MIH AS to make handover related decisions. The handover related decisions are performed by implementing the Media Independent Handover Function (MIHF) entity, as standardized by the IEEE 802.21 Working Group, and an upper-level mobility management entity called the Mobility Controller. This concept is shown in FIGS. 1A and 1B.

The 3GPP group has mapped messages of a particular interface, the Sh interface, onto the Diameter Protocol. Table 1 shows information elements (IEs) that are accessible via the Sh interface. The Diameter protocol is an Internet Engineering Task Force (IETF) protocol for authentication, authorization and accounting.

TABLE 1
Data accessible via Sh interface

| Data | | Defined | | |
|---|---|---|---|---|
| Ref. | XML tag | in | Access key | Operations |
| 0 | RepositoryData | 7.6.1 | IMS Public User Identity or | Sh-Pull, Sh-Update, |
| | | | Public Service Identity + | Sh-Subs-Notif |
| | | | Data-Reference + Service- | |
| | | | Indication | |
| 10 | IMSPublicIdentity | 7.6.2 | IMS Public User Identity | Sh-Pull |
| | | | or Public Service Identity or | |
| | | | MSISDN + Data-Reference + | |
| | | | Identity-Set (values other than | |
| | | | ALIAS_IDENTITIES) | |
| 10 | IMSPublicIdentity | 7.6.2 | IMS Public User Identity + | Sh-Pull, Sh-Subs-Notif |
| | | | Data-Reference + Identity-Set | |
| | | | (with value | |
| | | | ALIAS_IDENTITIES) | |
| 11 | IMSUserState | 7.6.3 | IMS Public User Identity + | Sh-Pull, Sh-Subs-Notif |
| | | | Data-Reference | |
| 12 | S-CSCFName | 7.6.4 | IMS Public User Identity or | Sh-Pull, Sh-Subs-Notif |
| | | | Public Service Identity + | |
| | | | Data-Reference | |
| 13 | InitialFilterCriteria | 7.6.5 | IMS Public User Identity or | Sh-Pull, Sh-Subs-Notif |
| | | | Public Service Identity + | |
| | | | Data-Reference + Server- | |
| | | | Name | |
| 14 | LocationInformation | 7.6.6 | MSISDN + Data-Reference+ | Sh-Pull |
| 15 | UserState | 7.6.7 | Requested-Domain | |
| 16 | Charging information | 7.6.8 | IMS Public User Identity or | Sh-Pull |
| | | | Public Service Identity or | |
| | | | MSISDN + Data-Reference | |
| 17 | MSISDN | 7.6.9 | IMS Public User Identity or | Sh-Pull |
| | | | MSISDN + Data-Reference | |
| 18 | PSIActivation | 7.6.10 | Distinct Public Service Identity + | Sh-Pull, Sh-Update, |
| | | | Data-Reference | Sh-Subs-Notif |
| 19 | DSAI | 7.6.11 | Public User Identity or Public | Sh-Pull, Sh-Update, |
| | | | Service Identity + Data- | Sh-Subs-Notif |
| | | | Reference + DSAI-Tag + | |
| | | | Server-Name | |
| 20 | AliasesRepositoryData | 7.6.12 | IMS Public User Identity + | Sh-Pull, Sh-Update, |
| | | | Data-Reference + Service- | Sh-Subs-Notif |
| | | | Indication | |

For the Diameter application standardized by 3GPP the Application ID is 16777217. The Sh interface messages map onto the standardized Diameter protocol messages as shown in the Table 2.

TABLE 2
Sh message to Diameter Command mapping

| Sh message | Source | Destination | Command-Name | Abbreviation |
|---|---|---|---|---|
| Sh-Pull | AS | HSS | User-Data-Request | UDR |
| Sh-Pull Resp | HSS | AS | User-Data-Answer | UDA |
| Sh-Update | AS | HSS | Profile-Update-Request | PUR |
| Sh-Update Resp | HSS | AS | Profile-Update-Answer | PUA |
| Sh-Subs-Notif | AS | HSS | Subscribe-Notifications-Request | SNR |
| Sh-Subs-Notif Resp | HSS | AS | Subscribe-Notifications-Answer | SNA |
| Sh-Notif | HSS | AS | Push-Notification-Request | PNR |
| Sh-Notif Resp | AS | HSS | Push-Notification-Answer | PNA |

The Command Names shown in Table 2 have Command Codes that are used in the Diameter header, as shown in FIG. 2. A list of the command codes is shown in Table 3.

TABLE 3
Command Codes in Diameter Header

| Command-Name | Abbreviation | Code | Section |
|---|---|---|---|
| User-Data-Request | UDR | 306 | 6.1.1 |
| User-Data-Answer | UDA | 306 | 6.1.2 |
| Profile-Update-Request | PUR | 307 | 6.1.3 |
| Profile-Update-Answer | PUA | 307 | 6.1.4 |
| Subscribe-Notifications-Request | SNR | 308 | 6.1.5 |
| Subscribe-Notifications-Answer | SNA | 308 | 6.1.6 |
| Push-Notification-Request | PNR | 309 | 6.1.7 |
| Push-Notification-Answer | PNA | 309 | 6.1.8 |

### SUMMARY

A method and apparatus that allows the MIH Application Server in a wireless or fixed network communication system to download user preferences and subscriptions from the Home Subscription Server (HSS) are disclosed. The method and apparatus allow an IMS based handover server to extract user preference and subscription information from a subscription server. This improvement allows new kinds of information to be exchanged between the handover and subscription server for optimized handover decisions. The MIH AS may use this information to update its database. The MIH AS may also allow the Mobility Controller, residing within it, to use this information to assist the MIHF logical entity, also residing within it, to make handover related decisions.

### BRIEF DESCRIPTION OF THE DRAWINGS

A more detailed understanding may be had from the following description, given by way of example and to be understood in conjunction with the accompanying drawings wherein:

FIGS. 1A and 1B are diagrams of an existing system and protocol for handover related decisions; and

FIG. 2 is a diagram of an existing header format;

FIG. 3 is a flow chart of a method of obtaining information about user preferences and subscriptions;

FIGS. 4A and 4B are flow charts of a method of updating the user data; and

FIG. 5 is a block diagram of a wireless communication system.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless or fixed network environment. When referred to hereafter, the terminology “base station” includes but is not limited to a Node-B, a site controller, an access point (AP), or any other type of interfacing device capable of operating in a wireless or fixed network environment.

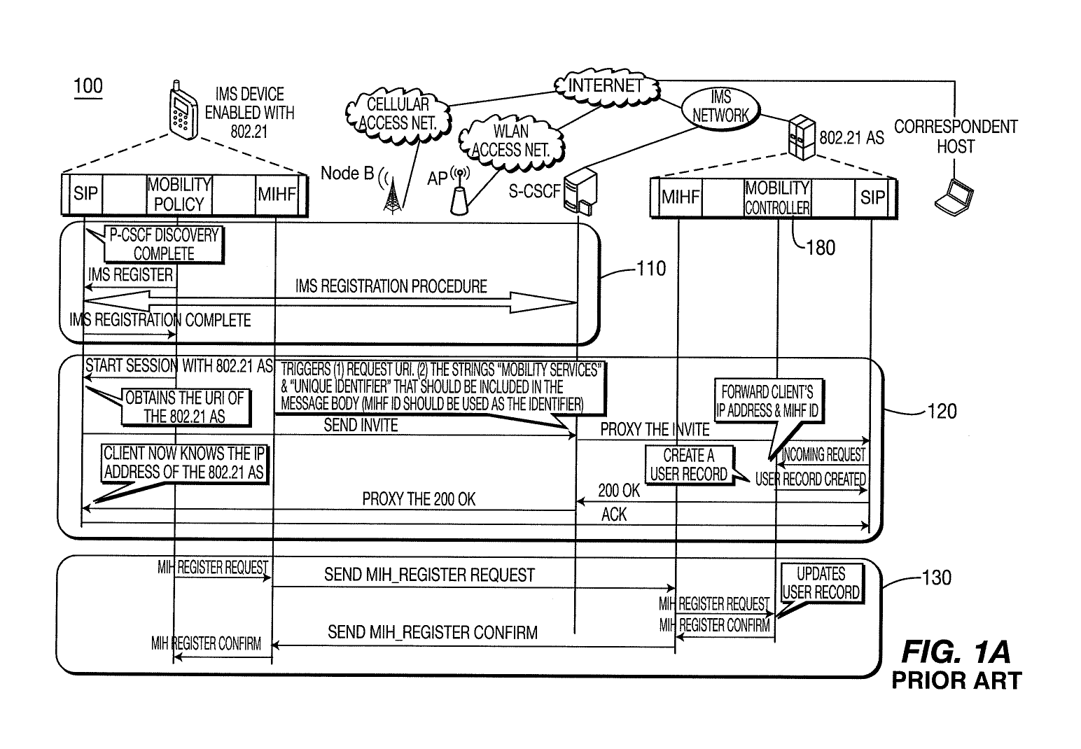

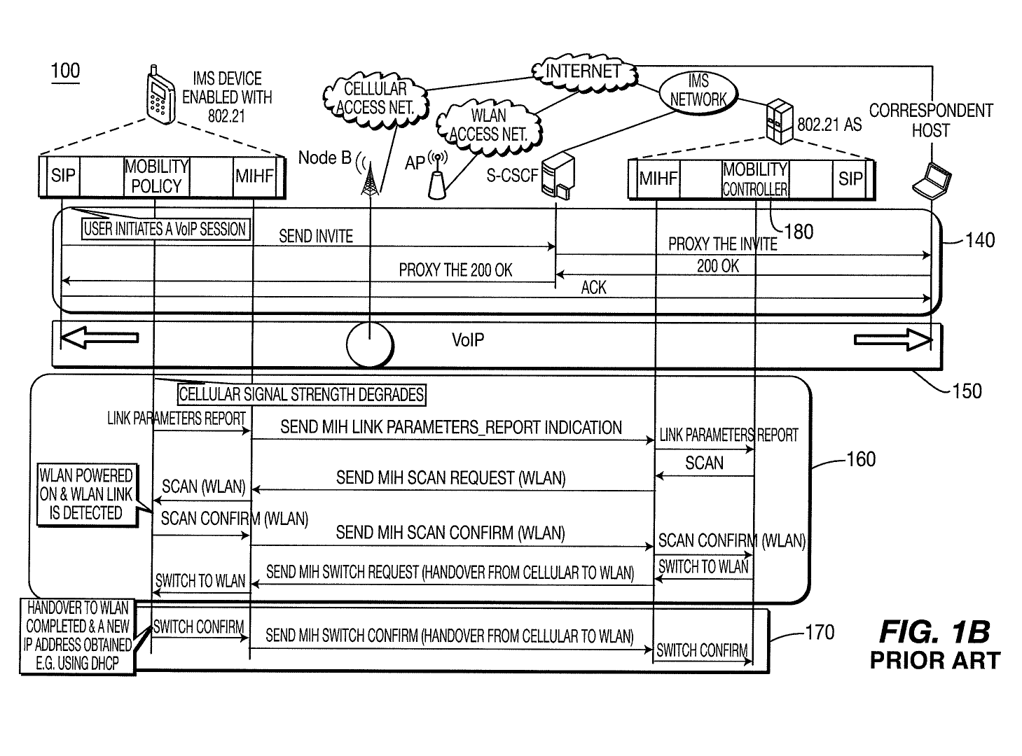

FIG. 1A is a diagram of an existing system and protocol 100 for handover related decisions. The protocols shown in FIG. 1A include normal IMS registration 110, session setup with 802.21 AS using SIP 120 (signaling plane), and 802.21 registration 130 (user plane—directly over IP with IPsec, where IPsec is the security standard for IP traffic). The wireless or fixed network operator may operate several different IMS domains. The user selects the access to a specific IMS domain by means of his ISIM (IMS SIM) application contained in his UICC/SIM card. In this example, the operator assigns a specific IMS domain by means of the S-CSCF selection process where the corresponding MIH AS resides 110.

FIG. 1B is a diagram of an existing system and protocol 100 for handover related decisions. The protocols shown in FIG. 1B include VoIP session setup 140, VoIP data exchange 150, reporting of standardized 802.21 link events to initiate the inter-technology handover 160, and standardized 802.21 commands used to control links and execute the handover 170.

As can be seen from the signal flow diagrams and the prototype architecture in FIGS. 1A and 1B, the Mobility Controller should decide whether to switch the user to the WLAN, or in general, any other RAT. To make an informed decision the Mobility Controller 180 needs to have the user subscription profile and preferences which are generally stored in the HSS (not shown) to which it currently has no ready access. This is the problem that the embodiments discussed below aim to solve.

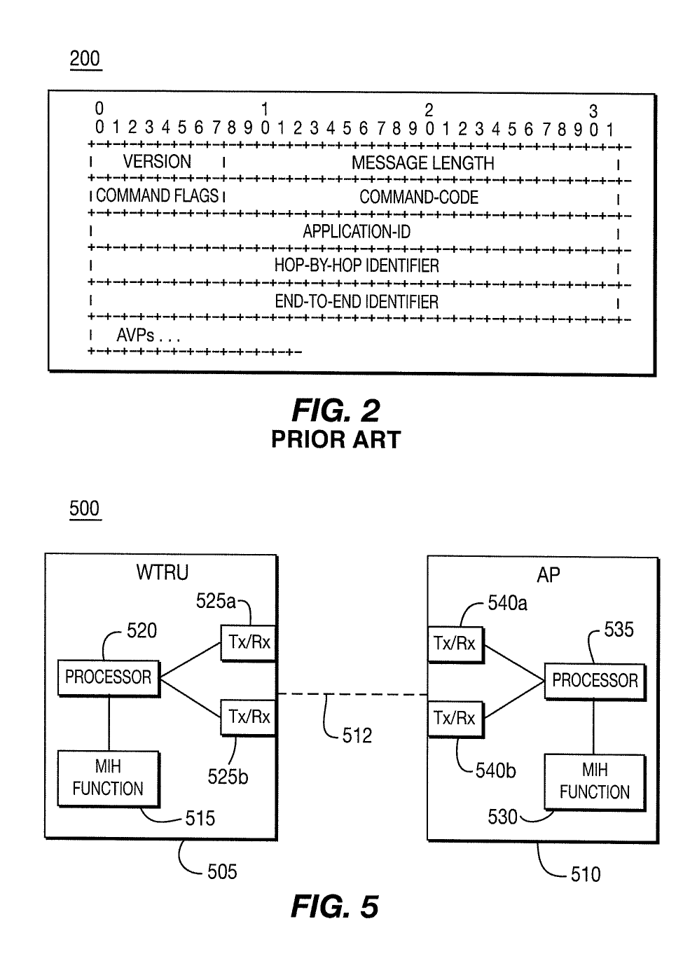

FIG. 2 is a diagram of an existing header format 200. The Sh interface, mapped to the Diameter protocol, runs over TCP and has a header format as shown in FIG. 2.

To overcome the problems discussed above, a method to assist a media-independent network handover which can enable a first server to obtain information about a WTRU is needed. This method can apply to, for example, an IMS-based server or an MIH server in the IMS domain. Upon receiving network link information from the WTRU, the server may transmit identity information for the WTRU to a subscription server. The network link information can include, but is not limited to, radio strength measurements, traffic loss parameters, bit error rate information, or a handover request. Upon receiving information from the subscription server, the first server decides whether to handover the WTRU to a new network.

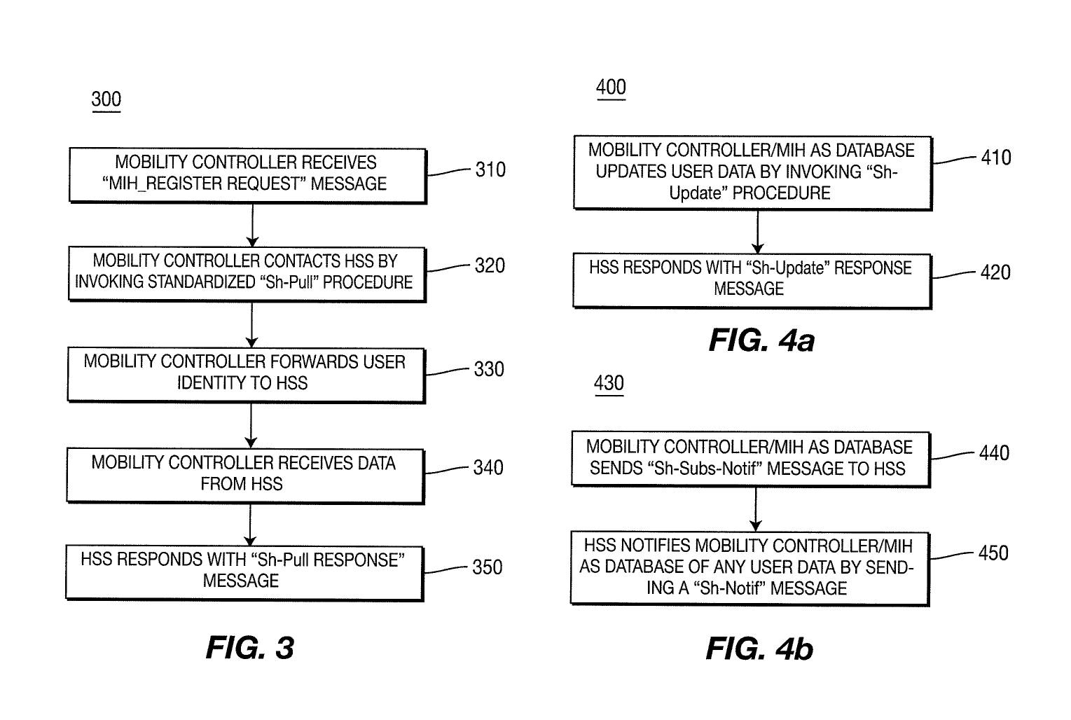

FIG. 3 is a flow chart of a method of obtaining information about user preferences and subscriptions 300 using an optional Sh interface. The MIH AS (through the Mobility Controller) contacts the HSS using the optional Sh interface that has been standardized by the 3GPP group for interaction between the HSS and an IMS Application Server, as described above.

Upon receiving a ‘MIH_Register Request’ message from an IMS registered user 310, the Mobility Controller is expected to contact the HSS by invoking the standardized ‘Sh-Pull’ procedure 320. This procedure allows the Mobility Controller to forward the User Identity to the HSS 330 and receive data that is stored for the user in the HSS 340. The HSS responds with a “Sh-Pull Response” message 350 that contains the User Data stored as an Attribute Value Pair (AVP) containing the Information Elements (IE's) shown in Table 1.

In another embodiment of the present invention, information is added to the information list supplied by the HSS, shown in Table 1. An Information Element (IE) called “Allowed Networks” is added to the list shown in Table 1 that includes the Network IDs of all operators that the home operator has a roaming agreement with and that the user has subscribed for.

The creation of additional IEs would allow the Mobility Controller to make a handover decision if the WTRU detects a foreign network. One example would be to create an IE called “User Preferences”. This “User Preferences” IE preferably contains such information as whether the user preferences pertain to cost to connect to the network or the speed of the network, for example. Another example would be to enhance the Location Information IE, in Table 1, with information (geographical, for example) that would allow the MIH AS to determine (using its database) if a different MIH AS in closer proximity to the WTRU exists.

FIGS. 4A and 4B are flow charts of a method of updating the user data. As shown in FIGS. 4A and 4B, the Mobility Controller/MIH AS database may, at any time, update the user data by invoking the “Sh-Update” procedure 410 to which the HSS is expected to respond with the “Sh-Update Response” message 420. The Mobility Controller/MIH AS database may also subscribe to notifications of update in user data profile 430 by sending a “Sh-Subs-Notif” message to the HSS 440. The HSS in turn may notify the Mobility Controller/MIH AS database of any updates in the User Data by sending a “Sh-Notif” message 450.

FIG. 5 is a block diagram of a wireless communication system 500 including a wireless transmit receive unit 505 and an AP 510. The WTRU 505 and the AP 510 communicate via a wireless communication link, 512.

As shown in FIG. 5, the WTRU 515 includes an MIH function (MIHF) 515, a processor 520, at least one transceiver (525a, 525b). The processor 520 is attached to the MIHF 515 and each of the transceivers 525a, 525b. The MIHF 515 is configured to carry out media independent handover related processes, including generating an MIH capabilities discovery request, and processing an MIH capabilities response.

Also shown in FIG. 5, the AP 510 includes an MIHF 530, a processor 535, at least one transceiver (540a, 540b). The processor 535 is attached to the MIHF 530 and each of the transceivers 540a, 540b. The MIHF 530 is configured to carry out media independent handover related processes, including processing an MIH capabilities discovery request, and generating an MIH capabilities response. Optionally, the MIHF 530 may be located outside of the AP 510 in the network (not shown). For example, the AP 510 may be connected to an access router (not shown) which may house the MIHF 530.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method enabling a Media Independent Handover (MIH) server to obtain information about a wireless transmit/receive unit (WTRU) for assisting media-independent network handover, the method comprising:
receiving network link information including WTRU identity information;
transmitting the WTRU identity information to a subscription server;
receiving user information from a subscription server based on the WTRU identity information, wherein the user information received from the subscription server comprises a user preference information element; and
deciding whether to handover the WTRU to a new network based on the received user information.

2. The method of claim 1, wherein the MIH server is an Internet Protocol Multimedia Subsystem (IMS)-based handover server in a wireless or fixed network communication system.

3. The method of claim 1, wherein the network link information includes a radio strength measurement.

4. The method of claim 1, wherein the network link information includes traffic loss parameters.

5. The method of claim 1, wherein the network link information includes bit error rate information.

6. The method of claim 1, wherein the network link information includes a handover request.

7. The method of claim 1, wherein the network link information includes a network handover request in the form of a MIH_Register Request message.

8. The method of claim 1, wherein the WTRU is an internet protocol multimedia subsystem (IMS) registered user.

9. The method of claim 1, wherein the user preference information element includes preferences selected from network speed preferences and network usage cost preferences.

10. The method of claim 1, wherein the information received from the subscription server comprises network identification information.

11. The method of claim 10, wherein the network identification information comprises information on which networks the WTRU is allowed to connect to.

12. The method of claim 11, wherein the allowable networks comprise networks having operators with which a home operator has a roaming agreement and to which the WTRU is subscribed.

13. The method of claim 1, further comprising:
receiving geographical information from the subscription server based on the WTRU identity; and
determining if there is another MIH server in a closer proximity to the WTRU based on the received geographical information.

14. The method of claim 1, further comprising:
updating a user database in the MIH server based on the information received from the subscription server.

15. The method of claim 14, wherein the MIH server is a Media Independent Handover application server (MIH-AS) in a wireless or fixed network communication system.

16. The method of claim 15, wherein the MIH-AS comprises a mobility controller which makes the handover decision.

17. The method of claim 1, further comprising the subscription server sending a response message containing user data stored as an attribute value pair.

18. The method of claim 17, wherein the response message is in the form of a Sh-Pull Response message.

19. A Media Independent Handover (MIH) server configured to obtain information about a wireless transmit/receive unit (WTRU) for assisting handover, the MIH server comprising:
a receiver configured to receive information from a WTRU;
a processor configured to extract the identity of the WTRU;
a transmitter configured to transmit the identity to a subscription server;
a receiver configured to receive from the subscription server; and
the processor configured to decide whether to handover the WTRU to a new network.

20. The MIH server of claim 19, wherein the exchanged information comprises user preference information.

21. The MIH server of claim 20, wherein the user preference information comprises preferences selected from network speed preferences and network usage cost preferences.

22. The MIH server of claim 19, wherein the exchanged information comprises network identification information.

23. The MIH server of claim 22, wherein the network identification information comprises information on which networks the WTRU is allowed to connect to.

24. The MIH server of claim 23, wherein networks the WTRU is allowed to connect to comprise networks having operators with which a home operator has a roaming agreement and to which the WTRU is subscribed.

25. The MIH server of claim 19, wherein the exchanged information comprises geographical information.

26. The MIH server of claim 25, wherein the second processor is configured to determine, using the geographical information, if there is a second server in closer proximity to the WTRU than the first server.

27. The MIH server of claim 19, wherein the exchanging information between the first server and the subscription server comprises a Third Generation Partnership Project (3GPP) standardized interface.

28. The MIH server of claim 27, wherein the standardized 3GPP interface is an Sh interface.
